(19) United States
(12) Patent Application Publication
(10) Pub. No.: US 2025/0005347 A1
(43) Pub. Date: Jan. 2, 2025

(54) COUNTERFACTUAL PREDICTION AND INTERPRETABLE POLICY LEARNING FROM OBSERVATIONAL DATA USING PRESCRIPTIVE RELU NETWORKS

(71) Applicant: INTERNATIONAL BUSINESS MACHINES CORPORATION, Armonk, NY (US)

(72) Inventors: Wei Sun, Scarsdale, NY (US); Markus Ettl, Yorktown Heights, NY (US); Asterios Tsiourvas, Cambridge, MA (US)

(21) Appl. No.: 18/217,091

(22) Filed: Jun. 30, 2023

(51) Int. Cl. G06N 3/08

(52) U.S. Cl. CPC G06N 3/08

(57) ABSTRACT

A method, system, and computer program product are configured to: train an artificial neural network (ANN) model using a dataset comprising observational data including treatment data, outcome data, and covariate data, wherein the ANN model includes rectified linear unit (ReLU) activation functions and K number of output nodes corresponding to K number of treatment options; and create a prescriptive tree based on the ANN model, wherein each leaf node of the prescriptive tree corresponds to one of the treatment options, and wherein the prescriptive tree is configured to indicate one of the treatment options for a particular set of features of the covariate data.

### BACKGROUND

Aspects of the present invention relate generally to computer-based approaches to determining a best treatment option based on an individual's characteristics and, more particularly, to counterfactual prediction and interpretable policy learning from observational data using prescriptive rectified linear unit (ReLU) networks.

### SUMMARY

In accordance with aspects of the invention, a method, system, and computer program product are configured to: train an artificial neural network (ANN) model using a dataset comprising observational data including treatment data, outcome data, and covariate data, wherein the ANN model includes rectified linear unit (ReLU) activation functions and K number of output nodes corresponding to K number of treatment options; and create a prescriptive tree based on the ANN model, wherein each leaf node of the prescriptive tree corresponds to one of the treatment options, and wherein the prescriptive tree is configured to indicate one of the treatment options for a particular set of features of the covariate data. The prescriptive tree that is derived from the an ReLU based ANN in accordance with aspects of the invention provides superior prescriptive accuracy compared to other benchmark prescriptive methods.

In embodiments, training the ANN model comprises using a loss function that is based on prescription outcome and prediction error. By basing the loss function on both prescription outcome and prediction error, the model is trained to be both optimal and accurate, which outperforms models that optimize based on prescription outcome alone. In embodiments, training the ANN model comprises adjusting values of weights of the ANN model using the loss function and gradient descent. Training using gradient descent permits the model to be trained efficiently.

In embodiments, the prescriptive tree comprises an oblique tree with hyperplane splits created using multiple weights per neuron in the ANN model. An oblique tree is advantageously more powerful than other trees.

In embodiments, the prescriptive tree comprises an axis-aligned tree created by setting a single weight per neuron in the ANN model. An axis-aligned tree is advantageously more interpretable than other trees.

In embodiments, the ANN model takes a number of non-zero weights connected to each neuron as an input parameter. This advantageously balances the model complexity and interpretability.

In embodiments, at each epoch during the training, the ANN model retains only a subset of neurons with the largest weights. This is referred to as weight pruning and creates a sparser network, which advantageously enhances interpretability of the predictive tree.

In embodiments, one or more constraints are incorporated into the model. This advantageously provides a model and prescriptive tree that accommodate the common requirement of prescription tasks in practice to adhere to constraints.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows results of prescription accuracy for different models in accordance with aspects of the present invention.

FIG. 4 shows a diagram of training a prescriptive ReLU neural network to construct prescriptive trees in accordance with aspects of the present invention.

FIG. 5A shows an exemplary ReLU neural network comprising one hidden layer, two neurons, and two outputs corresponding to two treatment options in accordance with aspects of the present invention.

FIG. 5B shows a graph a of a partition of the input space of the ReLU neural network of FIG. 5A in accordance with aspects of the present invention.

FIG. 5C shows the graph of FIG. 5B after partitioning a partition into treatment regions in accordance with aspects of the present invention.

FIG. 6 shows a table that compares mean prescription accuracy for various methods including a model in accordance with aspects of the present invention.

FIG. 7A shows an example of an oblique prescriptive tree with multivariate splits in accordance with aspects of the present invention.

FIG. 7B shows an example of an axis aligned prescriptive tree in accordance with aspects of the invention.

FIG. 8A shows an example of a constrained prescriptive ReLU neural network in accordance with aspects of the present invention.

FIG. 8B shows a graph of a partitioning of the input space of the constrained prescriptive ReLU neural network of FIG. 8A in accordance with aspects of the present invention.

FIGS. 9A and 9B show exemplary prescriptive trees in accordance with aspects of the present invention.

FIG. 10 shows a flowchart of an exemplary method in accordance with aspects of the present invention.

### DETAILED DESCRIPTION

Aspects of the present invention relate generally to computer-based approaches to determining a best treatment option based on an individual's characteristics and, more particularly, to counterfactual prediction and interpretable policy learning from observational data using prescriptive rectified linear unit (ReLU) networks.

The task of determining the best treatment option based on an individual's characteristics from data is a central problem across many domains including ad targeting in digital marketing, personalized pricing in revenue management, and individualized treatments in precision medicine, to name but a few examples. In many such scenarios, only observational data is available, meaning that the data includes features that describe the instance (e.g., a patient or a customer), the treatment prescribed, and the outcome associated with the administered treatment. One of the key challenges in learning from observational data is that one can only observe the response for the chosen action, but not the counterfactual outcomes associated with other alternative treatments for a given instance. One way to circumvent this issue is by using randomized controlled trials (RCTs) where samples are assigned to treatments at random. However, due to high cost, RCTs are typically limited in scope and can be outright infeasible in many settings. Another challenge of policy optimization is the need for interpretability. Complex and opaque policies not only make implementation cumbersome but also are difficult for companies to understand or trust.

Implementations of the invention address these problems by providing a method, system, and computer program product that learn optimal policy from a set of discrete treatment options using observational data. Embodiments include a piecewise linear neural network model that can balance strong prescriptive performance and interpretability, which is referred to herein as a prescriptive ReLU network, or P-ReLU. In embodiments, this model (i) partitions the input space into disjoint polyhedra, where all instances that belong to the same partition receive the same treatment, and (ii) is converted into an equivalent prescriptive tree with hyperplane splits for interpretability. Embodiments provide for flexibility of the P-ReLU network as constraints can be easily incorporated with minor modifications to the architecture. Experiments validate the superior prescriptive accuracy of P-ReLU against competing benchmarks. Examples of prescriptive trees extracted from trained P-ReLUs using a real-world dataset are presented for both the unconstrained and constrained scenarios.

Interpretable optimal policy may be learned from data in the form of prescriptive trees in which all samples in a leaf node are prescribed the same treatment, and each path from the root node to a leaf node corresponds to a policy. Trees can be constructed greedily or optimally using a mixed integer programming (MIP) approach. While the latter provides some degree of optimality, scalability remains an unsolved challenge due to the number of binary decision variables limiting such approaches to shallow trees with small datasets of no more than a few thousand samples. The procedure of constructing prescriptive trees can also differ in how the counterfactuals are estimated from observational data. The prediction step can be explicitly decoupled from the policy optimization; however, the propensity scores needed as input are not always available or reliable. Alternatively, the counterfactual estimation step can be embedded in the policy generation, yielding an integrated approach. In conventional methods, the counterfactual model is restricted to constant or linear functions because it needs to be evaluated at every node of a tree. This limitation potentially leads to significant model misspecification when the underlying outcome function takes a more complex form.

Implementations of the invention provide a technical improvement over conventional methods by providing a model that uses a ReLU neural network that is not limited to piecewise-constant functions to model counterfactuals. Such a model is more expressive than conventional models because it is not limited to constant or linear functions. In particular, embodiments utilize a ReLU neural network that can approximate any continuous function to model the counterfactuals, thus providing an improvement over conventional methods that are limited to using constant or linear functions to model the counterfactuals. Such a model can also be used to generate policies that are more interpretable than conventional models. In particular, implementations provide the benefit of permitting end-users to choose the output as an oblique tree (with multivariate splits, more powerful but less interpretable) or an axis-aligned tree (with single-variate splits, less powerful but more interpretable).

Implementations of the invention are necessarily rooted in computer technology. For example, the step of training an artificial neural network (ANN) is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, demographic information, diagnostic information, genetic information, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as policy learning code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

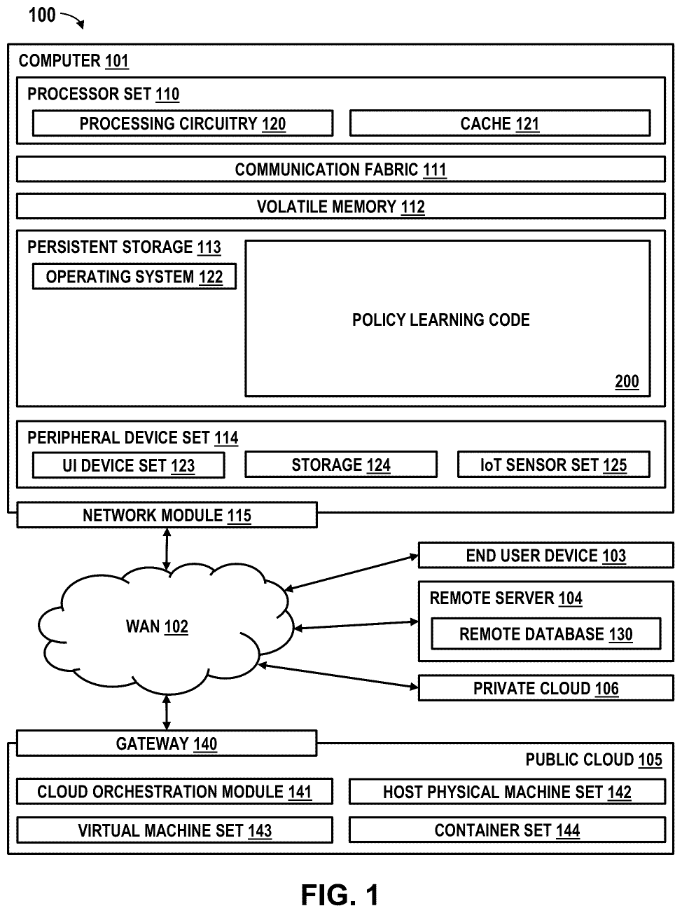

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

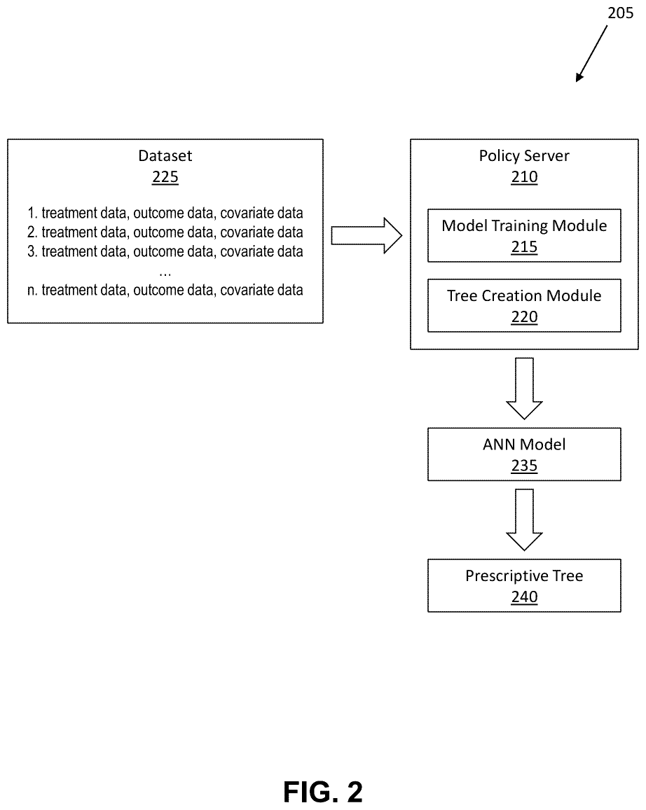

FIG. 2 shows a block diagram of an exemplary environment 205 in accordance with aspects of the invention. In embodiments, the environment 205 includes a policy server 210 that may comprise one or more instances of the computer 101 of FIG. 1, or one or more virtual machines or containers running on one or more instances of the computer 101 of FIG. 1.

In embodiments, the policy server 210 of FIG. 2 comprises a model training module 215 and tree creation module 220, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The policy server 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the model training module 215 is configured to train an artificial neural network (ANN) model 235 using a dataset 225. In embodiments, the dataset 225 consists of observational data including treatment data, outcome data, and covariate data for n number of individuals. In embodiments, the model training module 215 uses one or more machine learning algorithms to train the ANN model 235 using the dataset 225. In embodiments, training the ANN model 235 comprises using a loss function that is based on prescription outcome and prediction error. In embodiments, training the ANN model 235 comprises adjusting values of weights of the ANN model 235 using the loss function and stochastic gradient descent. In embodiments, the ANN model 235 includes rectified linear unit (ReLU) activation functions and K number of output nodes corresponding to K number of treatment options.

In accordance with aspects of the invention, the tree creation module 220 is configured to create a prescriptive tree 240 based on the ANN model 235. In embodiments, each leaf node of the prescriptive tree 240 corresponds to one of the treatment options. In embodiments, the prescriptive tree 240 is configured to indicate one of the treatment options for a particular set of features of the covariate data. In one example, the prescriptive tree 240 comprises an oblique tree with hyperplane splits created using multiple weights per neuron in the ANN model 235. In another example, the prescriptive tree 240 comprises an axis-aligned tree created by setting a single weight per neuron in the ANN model 235.

Referring again to the ANN model 235, in accordance with aspects of the invention the model training module 215 trains the ANN model 235 based on n number of observational data samples {(xₜ, Pₜ, yₜ)}ₜ₌₁ⁿ in the dataset 225, where xₜ∈×⊂ [symbol] are features that describe instance t(e.g., a customer or a patient), pₜ∈[K]:={0,1, . . . , K−1} is the policy or treatment taken, and yₜ∈ [symbol] is the observed outcome for the treatment. In embodiments, the model is created based on the convention that smaller outcomes are better than large outcomes. In embodiments, the data in the dataset 225 is observational meaning that there is no control of the historic administration of other treatments and no knowledge of counterfactuals (i.e., other treatments and outcomes for a given instance), such that yₜ(p) where p±pₜ are not known. In embodiments, the model is created based a function π: X→[K] that picks the best treatment out of the K possible treatment options for a given set of features (e.g., covariate data) x. In embodiments, the function π(x) is both optimal and accurate. In embodiments, optimal refers to minimizing the prescription outcome, i.e., [symbol] [y(π(x))], where the expectation is taken over the distribution of outcomes for a given treatment policy π(x). In embodiments, this prescription outcome is approximated in terms of the samples using Expression 1.

$${\sum }_{t = 1}^{n} ( {y}_{t} 𝕝 [ π ( {x}_{t} ) = {p}_{t} ] + {\sum }_{p \neq {p}_{t}} {\hat{y}}_{t} ( p ) 𝕝 [ π ( {x}_{t} ) = p ] ) \qquad ( 1 )$$

In Expression 1, ŷₜ(p) denotes the estimated outcome with treatment p for instance t. In embodiments, accuracy refers to minimizing the prediction error on the observed data. In embodiments, this prediction error is estimated using Expression 2.

$${{\sum }_{t = 1}}^{n} {( {y}_{t} - {\hat{y}}_{t} ( {p}_{t} ) )}^{2} \qquad ( 2 )$$

In embodiments, the model combines the prescription outcome of Expression 1 with the prediction error of Expression 2 as shown in Expression 3.

$$μ \cdot Prescription outcome + ( 1 - μ ) \cdot Prediction error \qquad ( 3 )$$

Expression 3 is a convex combination of Expression 1 and Expression 2 where μ∈[0,1] is a hyper-parameter that balances a trade-off between optimality and accuracy. The objective embodied in Expression 3 outperforms optimizing prescription outcome alone, e.g., such as where μ=1.

In accordance with aspects of the invention, the ANN model 235 is built on a feed-forward neural network with ReLU activations. By using a neural network with ReLU activations, π(x) is not limited to a tree structure a priori and is not limited to models that use only constant or linear functions to estimate counterfactuals. Embodiments use a densely connected architecture where each neuron in a hidden layer of the neural network takes as inputs the outputs of each neuron of the previous layer. In embodiments, in the output layer of the neural network the number of neurons is equal to the number K of treatment options. In this manner, for a given instance, each of the K number of output neurons approximates the outcome under the corresponding treatment. Embodiments assign the treatment with the lowest predicted outcome to each instance.

In accordance with aspects of the invention, the neural network of the ANN model 235 is denoted as ƒ_{θ}: X→ [symbol] where θ is the set of weights in the neural network. The number of hidden layers is denoted as L and the number of neurons at layer i is denoted as Nᵢ. The values of the neurons before activation is denoted as xⁱ∈ [symbol] and the values of the neurons after activation is denoted as zⁱ∈ [symbol] . The neurons are defined by the weight matrix Wⁱ∈ [symbol] and the bias vector as bⁱ∈ [symbol] . In this manner, xⁱ=Wⁱzⁱ⁻¹+bⁱ and zⁱ=σ(xⁱ) where σ(·) is the ReLU activation function. Using these notations, Expression 3 (which includes the prescription outcome of Expression 1 and the prediction error of Expression 2) can be rewritten as a loss function defined by Expression 4.

$$μ \cdot {\sum }_{t = 1}^{n} ( {y}_{t} 𝕝 [ {π}_{{f}_{θ}} ( {x}_{t} ) = {p}_{t} ] + {\sum }_{p \neq {p}_{t}} {{f}_{θ} ( {x}_{t} )}_{p} 𝕝 [ {π}_{{f}_{θ}} ( {x}_{t} ) = p ] ) + ( 1 - μ ) \cdot {\sum }_{t = 1}^{n} {( {y}_{t} - {{f}_{θ} ( {x}_{t} )}_{{p}_{t}} )}^{2} \qquad ( 4 )$$

In Expression 4, ƒ_{θ}(xₜ)ₚ is the predicted outcome to treatment p for instance xₜ by the network ƒ_{θ}(·), and the treatment prescribed by the network for instance xₜ, corresponding to the lowest predicted outcome, is given by Expression 5.

$${π}_{{f}_{θ}} ( {x}_{t} ) = arg {min}_{p ∈ [ K ]} {{f}_{θ} ( {x}_{t} )}_{p} \qquad ( 5 )$$

In embodiments, the model training module 215 learns the network (i.e., trains the ANN model 235) via gradient descent by minimizing Expression 4 for a dataset 225, e.g., by determining weights of the network that minimize the loss function. In this manner, training the ANN model 235 may comprise using a loss function (Expression 4) that is based on prescription outcome (Expression 1) and prediction error (Expression 2).

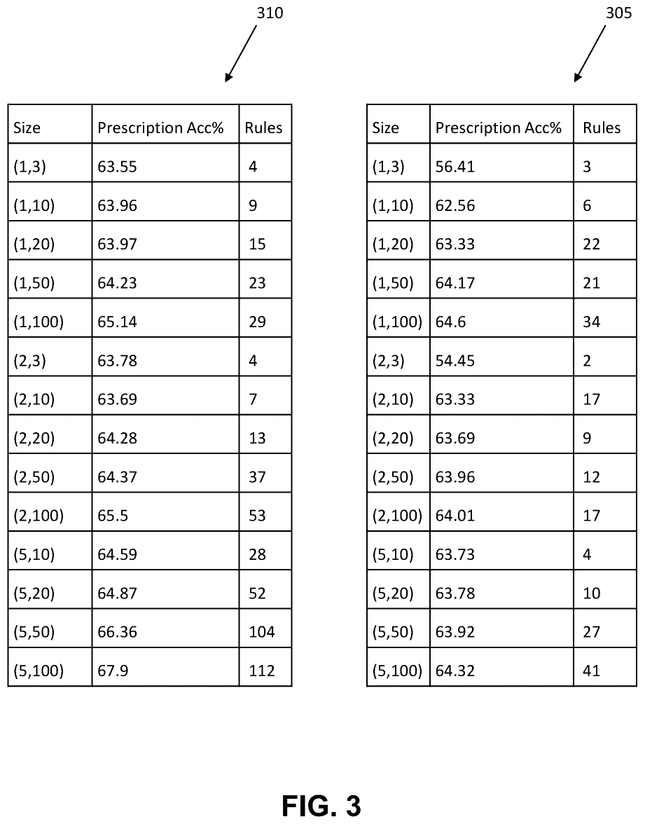

In embodiments, the neural network architecture of the ANN model 235 is adjusted to keep a subset (i.e., less than all) of the largest weights per neuron and to clip (e.g., ignore) the rest of the weights not in the subset. This may be performed at every epoch during training of the model. Clipping the weights per neuron in the manner leads to a sparser model, which enhances the interpretability of the policies. In one example, the neural network architecture of the ANN model 235 is adjusted to keep only one largest weight per neuron, which results in an axis aligned tree. Results for a sample dataset 225 using this first example are shown in table 305 of FIG. 3. In one example, the neural network architecture of the ANN model 235 is adjusted to keep a subset comprising more than one of the largest weights per neuron. In this example, each neuron is connected to m number of input where m is greater than 1 and less than the total number of inputs. This results in an oblique tree whose hyperplane cuts consist of at most m number of features. Results for a sample dataset 225 using this second example with m=2 are shown in table 310 of FIG. 3.

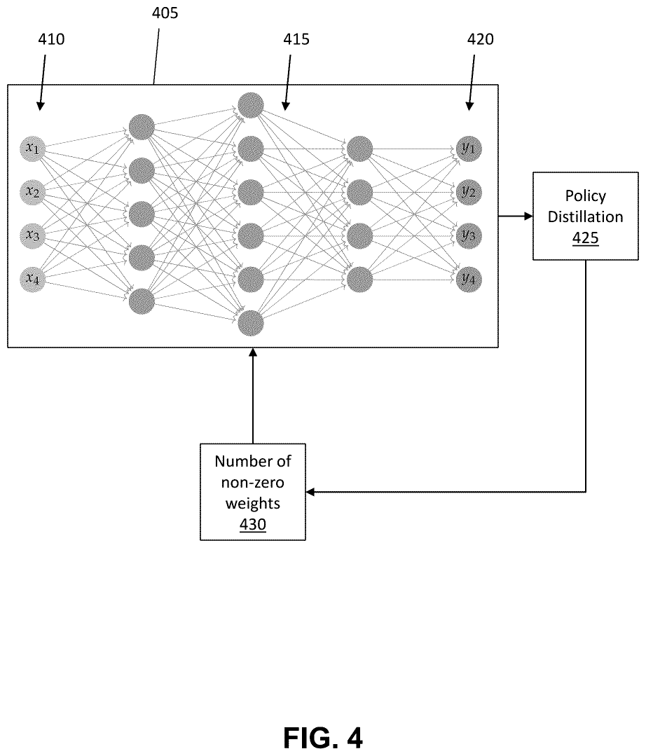

FIG. 4 shows a diagram of training a prescriptive ReLU neural network to construct prescriptive trees in accordance with aspects of the present invention. FIG. 4 shows a neural network 405 comprising inputs 410, hidden layers 415, and outputs 420. The inputs 410 correspond to the features x that describe an instance t, while the outputs 420 comprise K number of outputs corresponding to K number of treatment options y. In embodiments, the neural network 405 comprises a densely connected network (i.e., where each neuron receives inputs from all neurons in the pervious layer) with ReLU activation functions as described herein. In embodiments, the model training module 215 (FIG. 2) trains the neural network 405 using a dataset 225 (FIG. 2). In accordance with aspects of the invention, at block 425 the tree creation module 220 performs a policy distillation function in the form of creating a prescriptive tree based on the neural network 405, where the prescriptive tree can be an oblique tree or an axis aligned tree as described herein. Block 430 represents adjusting the number of non-zero weights to each neuron of the neural network to balance model complexity and interpretability. In one example, block 430 comprises setting the number of non-zero weights to each neuron to a value of one to create an axis aligned tree as described herein. In one example, block 430 comprises setting the number of non-zero weights to each neuron to a value of more than one to create an oblique tree as described herein.

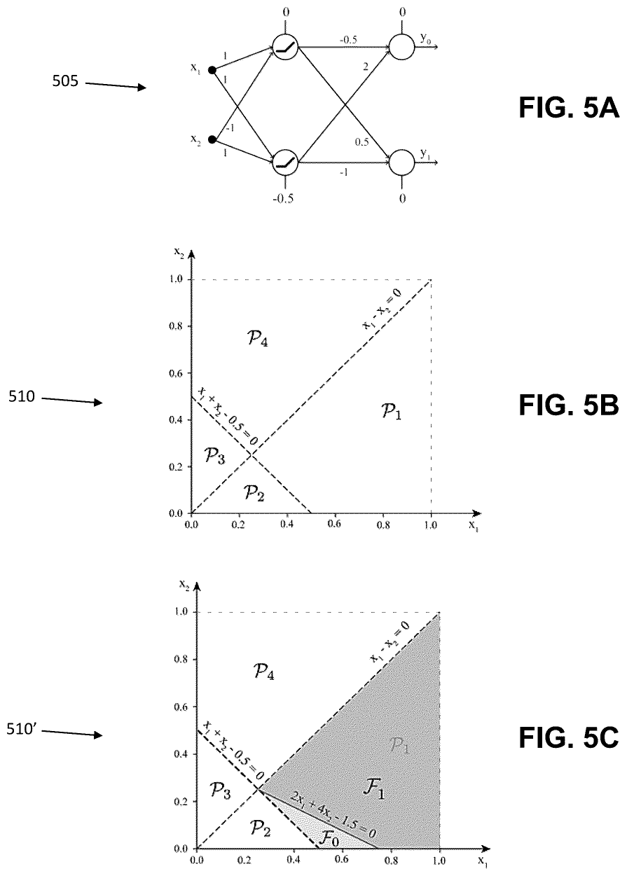

FIGS. 5A-C show an example of partitioning an input space in accordance with aspects of the present invention. In embodiments, the tree creation module 220 (FIG. 2) creates a prescriptive tree from the trained ANN model 235 (FIG. 2) by partitioning the input space X into disjoint treatment polyhedra, where all instances that belong to a same one of the polyhedra receive the same treatment. FIG. 5A shows an exemplary ReLU neural network 505 comprising one hidden layer, two neurons, and two outputs corresponding to two treatment options. The ReLU neural network 505 may be representative of a trained ANN model 235 (FIG. 2). As shown in FIG. 5A, the ReLU neural network 505 comprises inputs x₁ and x₂ and outputs y₁ and y₂, with weights and biases indicated on the edges. FIG. 5B shows a graph 510 of a partition of the input space X of the ReLU neural network 505 into four disjoint convex polyhedra P₁, P₂, P₃, and P₄ by the hidden layer of the ReLU neural network 505. In this example, the input space is defined by values of x₁ between 0.0 and 1.0 and values of x₂ between 0.0 and 1.0. FIG. 5C shows the graph 510′ after partitioning the partition P₁ into treatment regions F₀ and F₁. In embodiments, instances are assigned to the treatment with the lowest predicted response. By performing this procedure for every partition P₁, P₂, P₃, and P₄, the tree creation module 220 (FIG. 2) creates final partitions of the input space with corresponding prescribed treatments.

In embodiments, each partition of the input space is described by a finite number of hyperplane splits, resembling the behavior of a multivariate split tree, also referred to as an oblique tree. By prescribing the treatment with the minimum predicted outcome, the prescriptive ReLU neural network divides the initial polyhedron generated by the hidden layers into smaller polyhedra, where for all instances belonging to a smaller polyhedron the network prescribes the same constant treatment. Embodiments thus provide a method for creating a prescriptive tree comprising: training an expressive ReLU neural network via gradient descent; and transforming the trained network into a prescriptive tree. This method provides to a model with the expressiveness of a neural network, efficient computational training performance, as well as desirable properties associated with trees such as interpretability.

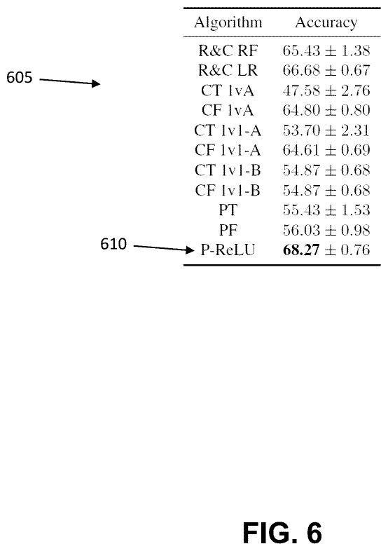

FIG. 6 shows a table 605 that compares mean prescription accuracy for various methods including a model in accordance with aspects of the present invention. A ReLU based model trained in accordance with aspects of the invention was tested against a personalization tree (PT), personalization forest (PF), causal tree (CT), causal forests (CF), the regress and compare approach with random forest (R&C RF) and the regress and compare approach with linear regression (R&C LR). The test was run using personalized warfarin dosing.

Warfarin is the most widely used oral anticoagulant agent worldwide according to the International Warfarin Pharmacogenetics Consortium. Finding the appropriate dose for a patient is difficult since it can vary by a factor of ten among patients and incorrect doses can contribute to severe adverse effects. The current guideline is to start the patient at 35 mg per week, and then vary the dosage based on how the patient reacts. A non-observational dataset that gives access to counterfactuals was used to establish a baseline. The dataset contains the true stable dose found by physician-controlled experimentation for thousands of patients. The patient covariates include demographic information (e.g., age, weight, height, gender, etc.), diagnostic information (reason for treatment, e.g., deep vein thrombosis, etc.), and genetic information (presence of genotype polymorphisms of CYP2C9 and VKORC1). The correct stable therapeutic dose of warfarin is segmented into three dose groups: Low (≤21 mg/week), Medium (>21,<49 mg/week), and High (≥49 mg/week), corresponding to p=0, 1 and 2 respectively.

As the dataset contains the correct treatment for each patient, one can develop a prediction model that treats the problem as a standard multi-class classification problem with full feedback which predicts the correct treatment given the covariates. Solving this classification problem gives an upper bound on the performance of prescriptive algorithms trained on observational data, as this is the best they could do if they had complete information. This exemplary use case considers random forest (RF), support vector classifier (SVC), logistic regression (LogReg), kNN, and XGBoost (XGB) classifier using scikit-learn. This use case performed a total of 10 runs. At each run the hyper-parameters of the classifiers are tuned by performing grid-search using cross-validation with 3 folds. The best prediction model by training with the ground truth dosage achieves an accuracy of 69.11% (i.e., the upper bound on performance due to the full-information setting).

In this use case, an observational dataset was created by modifying the initial, non-observational dataset. The observational dataset was created by considering the treatment chosen based on body mass index (BMI) according to probabilities defined by Expression 6.

$$ℙ [ P = p \vert X = x ] = \frac{1}{s} exp ( \frac{( p - 1 ) ( BMI - μ )}{σ} ) , for p = 0 , 1 , 2 \qquad ( 6 )$$

In Expression 6, μ and σ are the mean and standard deviation of the patient's BMI and S is a normalizing factor. The outcome yₜ(p) is set to be 1 if the does p is correct for instance t and is set to be 0 otherwise.

In this use case, the ANN model 235 comprises a prescriptive ReLU neural network with five hidden layers and 100 Neurons per layer that is trained using simulated datasets. The samples of the simulated datasets are generated with features x∈ [symbol] . All samples are independent and identically distributed, with odd-numbered features coming from a standard Gaussian distribution, and even-numbered features coming from a Bernoulli distribution with probability 0.5. To simulate observational studies, treatments are assigned based on multiple different propensity functions including univariate and multivariate, additive and interactive, and piecewise constant, linear, and quadratic, with the intent being to capture a wide variety of functional forms. Six datasets were created using different combinations of baseline and effect functions, where each dataset includes 10,000 training samples and 5,000 testing samples. Table 605 of FIG. 6 shows the mean prescription accuracy of the inventive model and the benchmarks based on performing ten runs using these observational datasets. As shown in table 605, the prescriptive ReLU based model having five layers and 100 neurons per layer (shown at 610), in accordance with aspects of the invention, has the highest mean prescription accuracy at 68.27%. This accuracy achieved using the observational dataset is only about 1% less than the highest accuracy for the multi-class classification problem with full information (i.e., with the non-observational dataset). In this manner, it can be seen that prescriptive ReLU based model outperforms other predictive algorithms when using an observational dataset, and approaches the accuracy of the best prediction model used with a non-observational dataset.

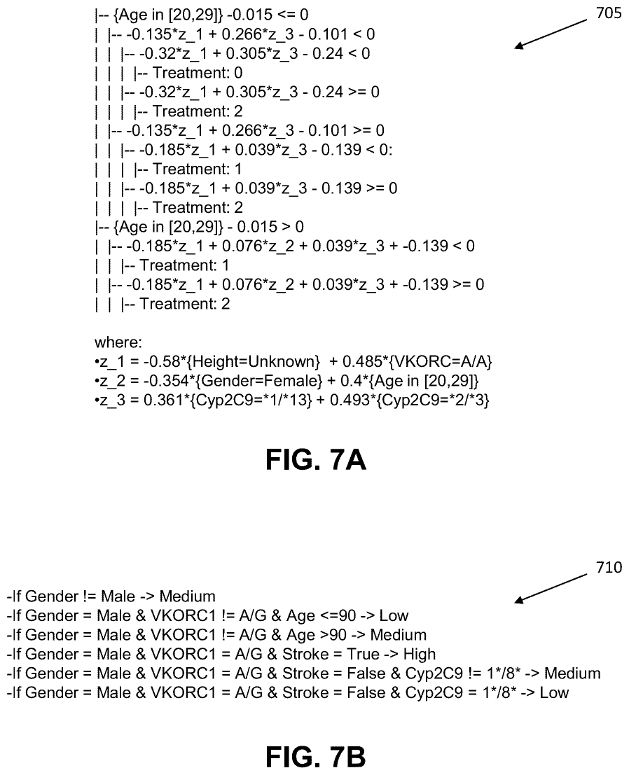

FIG. 7A shows an example of an oblique prescriptive tree 705 with multivariate splits for the personalized warfarin dosing use case in accordance with aspects of the invention. FIG. 7B shows an example of an axis aligned prescriptive tree 710 for the personalized warfarin dosing use case in accordance with aspects of the invention.

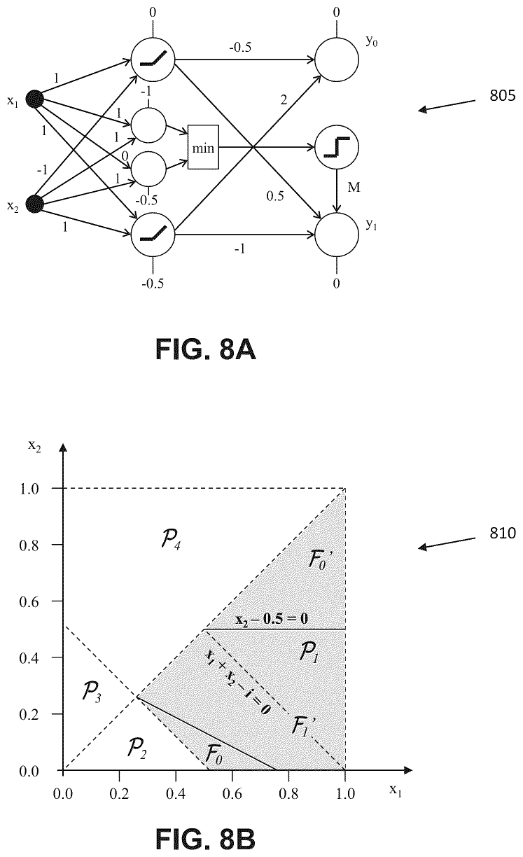

FIG. 8A shows an example of a constrained prescriptive ReLU neural network 805 in accordance with aspects of the present invention. A common requirement for prescription tasks in practice is to incorporate constraints. For example, in the medical domain, oftentimes it is necessary to enforce a patient's dose of medication to be below a certain limit, given their vital signs. Incorporating constraints is difficult for many tree-based prescriptive algorithms as they rely on recursive partitioning of the data, making it challenging to impose constraints across multiple branches of a tree. Implementations of the invention address this shortcoming of tree-based prescriptive algorithms by incorporating constraints in prescriptive ReLU neural network with minimal modification to the original network. In embodiments, a constraint is defined as shown in Expression 7.

$$if Ax > b then assign treatment that belongs in T \qquad ( 7 )$$

In Expression 7, A ∈ [symbol] , T⊂[K]. Embodiments explicitly impose such constraints by using c+1 extra neurons in the prescriptive ReLU neural network. In one example, for each linear constraint aᵢ^{T}x>bᵢ, i ∈ {1, . . . , c}, aᵢ is the i-th row of A and bᵢ is the i-th value of b. In this example, the system defines a neuron with a weight vector aᵢ∈ [symbol] and a bias term bᵢ∈ [symbol] , that takes an input x and outputs the value zᵢ^{con}(x)=aᵢ^{T}x−bᵢ. If zᵢ^{con}(x)>0, then the constraint is satisfied. In this example, the weights are pre-defined by the Expression 7, such that there is no need to train this part of the network, with the result being that the non-differentiable indicator activation function may be used. In this example, to impose the prescriptive rule, the system multiplies z^{con}(x) with a large number M and connects the output of this neuron to the output neurons of the treatments [K]\T. If z^{con}(x)=0, then then Ax>b is not satisfied, and the output of the model is not affected. If z^{con}(x)=1, then then Ax>b is satisfied, and a large value M is added to the output neurons that correspond to the treatments to be excluded. Adding a large value to these neurons ensures that the prescriptive ReLU neural network does not select the specific treatments, as the network assigns the treatment with the lowest predicted outcome to each instance.

The constrained prescriptive ReLU neural network 805 shown in FIG. 8A corresponds to the prescriptive ReLU neural network 505 of FIG. 5 but with additionally added neurons that incorporate explicitly the prescription constraints described in the example above. FIG. 8B shows a graph 810 of the partitioning of the input space of the prescriptive ReLU neural network 805 of FIG. 8A. Looking at the P₁ region in this example, it is seen that y₀=1.5x₁+2.5x₂−1 and y₁=−0.5x₁−1.5x₂+0.5+M· [symbol] [{min {x₁}+x₂−1, X₂−0.5}>0]. For every x₂>0.5 and x₁>1−0.5=0.5, it follows that y₁>y₀ since M>2x₁+4x₂−1.5. Therefore, the constrained prescriptive ReLU neural network 805 prescribes treatment 0 to all instances in [symbol] ={x∈ P₁: x₁>0.5, x₂>0.5}. Area [symbol] ₁′ is similarly obtained. This partition of P₁ is depicted in the graph 810 at areas [symbol] F₀′ and [symbol] ₁′. Specifically, based on adding the constraint to the ReLU neural network, the initial area F₁ shown in FIG. 5C is further partitioned into areas [symbol] ₀′ and [symbol] ₁′ in FIG. 8B. This example demonstrates that a constrained prescriptive ReLU neural network can have its input space partitioned into disjoint convex polyhedra as an oblique tree.

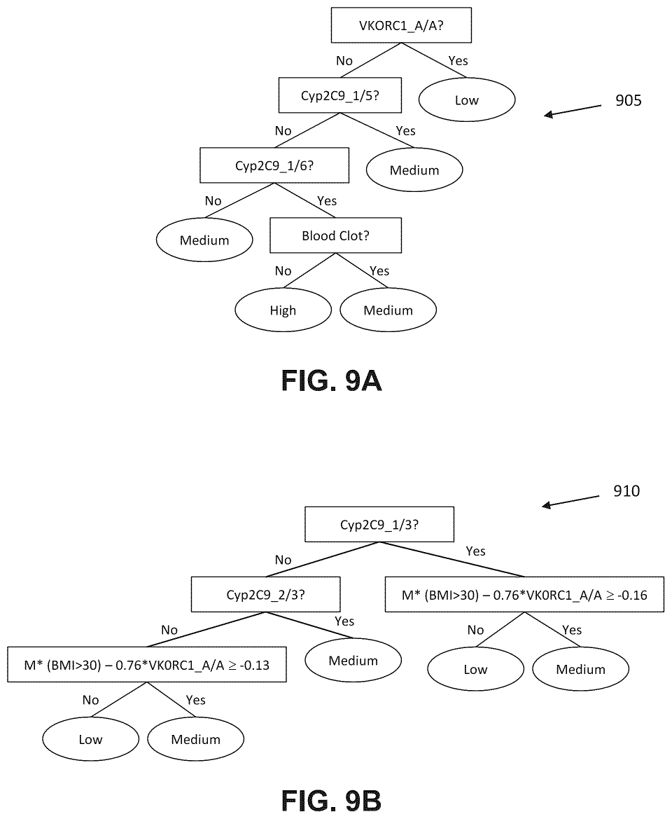

FIGS. 9A and 9B show exemplary prescriptive trees in accordance with aspects of the present invention. FIG. 9A shows a prescriptive tree 905 of the 1-layer prescriptive ReLU neural network for the unconstrained warfarin dosing use case. In this example, the model training module 215 (FIG. 2) trains the unconstrained prescriptive ReLU neural network using a dataset as described in the warfarin use case described above, and the tree creation module 220 (FIG. 2) creates the prescriptive tree 905 by partitioning the input space of the unconstrained prescriptive ReLU neural network. As shown in FIG. 9A, each leaf node of the prescriptive tree 905 corresponds to one of the treatment options (e.g., Low, Medium, and High in this example).

FIG. 9B shows a prescriptive tree 910 of a constrained 1-layer prescriptive ReLU neural network for the warfarin dosing use case. In this example, the model training module 215 (FIG. 2) trains the unconstrained prescriptive ReLU neural network using a dataset as described in the warfarin use case described above. The model training module 215 (FIG. 2) then generates the constrained prescriptive ReLU neural network by adding the constraint to the unconstrained prescriptive ReLU neural network. In this example, the constraint takes the form of: if BMI>30, then treatment in T{Medium, High}. The tree creation module 220 (FIG. 2) then creates the prescriptive tree 910 by partitioning the input space of the constrained prescriptive ReLU neural network. As shown in FIG. 9B, each leaf node of the prescriptive tree 910 corresponds to one of the treatment options (e.g., Low, Medium, and High in this example).

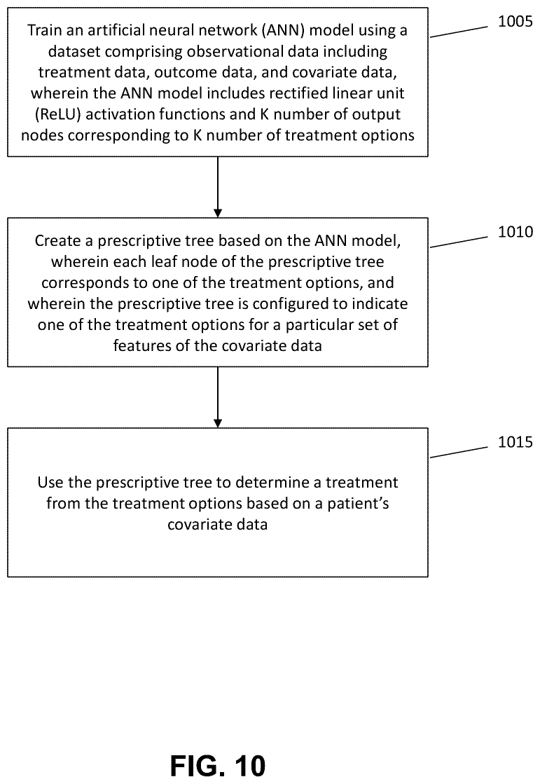

FIG. 10 shows a flowchart of an exemplary method in accordance with aspects of the present invention. Steps of the method may be carried out in the environment of FIG. 2 and are described with reference to elements depicted in FIG. 2.

At step 1005, the system trains an artificial neural network (ANN) model using a dataset comprising observational data including treatment data, outcome data, and covariate data. In embodiments, and as described with respect to FIG. 2, the model training module 215 trains the ANN model 235 using the dataset 225. In embodiments, the ANN model 235 comprises a prescriptive ReLU neural network as described herein, including ReLU activation functions and K number of output nodes corresponding to K number of treatment options.

At step 1010, the system creates a prescriptive tree based on the ANN model of step 1005. In embodiments, and as described with respect to FIG. 2, the tree creation module 215 creates the prescriptive tree 240 by partitioning the input space of the ANN model 235 into areas, where all instances of an area of a partition receive a same one of the respective treatment options. In particular, each leaf node of the prescriptive tree 240 corresponds to one of the treatment options, and the prescriptive tree 240 is configured to indicate one of the treatment options for a particular set of features of the covariate data.

At step 1015, the prescriptive tree of step 1010 is used to determine a treatment from the treatment options based on a patient's covariate data. This may be done manually by a user or automatically by the policy server.

From the foregoing, it can be seen that the present disclosure provides for a method, system, and computer program product for joint counterfactual estimation and optimal prescriptive policies generation which takes input data and passes it through a fully connected, dense neural net with ReLU activation functions and K output nodes corresponding to K treatments. In embodiments, the system considers both the prescription accuracy and the prediction accuracy in its objective. In embodiments, the method, system, and computer program product are used for producing policies corresponding to user-specified requirements on prescription accuracy and interpretability. In embodiments, the model takes the number of non-zero weights connected to each neuron as an input parameter. In embodiments, at every epoch during training, the model retains the largest weights at each neuron and clip the rest. The output is a sparser network. In embodiments, when setting a single weight per neuron, the output is a set of policies with a single feature in each rule, which can be represented by an axis-aligned tree. In embodiments, when allowing multiple weights per neuron, the output is a set of policies with multiple features in each rule, which can be represented by an oblique tree with hyperplane splits.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
training, by a processor set, an artificial neural network (ANN) model using a dataset comprising observational data including treatment data, outcome data, and covariate data, wherein the ANN model includes rectified linear unit (ReLU) activation functions and K number of output nodes corresponding to K number of treatment options; and
creating, by the processor set, a prescriptive tree based on the ANN model, wherein each leaf node of the prescriptive tree corresponds to one of the treatment options, and wherein the prescriptive tree is configured to indicate one of the treatment options for a particular set of features of the covariate data.

2. The computer-implemented method of claim 1, wherein the training the ANN model comprises using a loss function that is based on prescription outcome and prediction error.

3. The computer-implemented method of claim 2, wherein the training the ANN model comprises adjusting values of weights of the ANN model using the loss function and gradient descent.

4. The computer-implemented method of claim 1, wherein the prescriptive tree comprises an oblique tree with hyperplane splits created by using multiple weights per neuron in the ANN model.

5. The computer-implemented method of claim 1, wherein the prescriptive tree comprises an axis-aligned tree created by setting a single weight per neuron in the ANN model.

6. The computer-implemented method of claim 1, wherein the ANN model takes a number of non-zero weights connected to each neuron as an input parameter.

7. The computer-implemented method of claim 1, wherein, at each epoch during the training, the ANN model retains only a subset of weights per neuron.

8. The computer-implemented method of claim 1, further comprising incorporating one or more constraints in the ANN model.

9. A computer program product comprising one or more computer readable storage media having program instructions collectively stored on the one or more computer readable storage media, the program instructions executable to:
train an artificial neural network (ANN) model using a dataset comprising observational data including treatment data, outcome data, and covariate data, wherein the ANN model includes rectified linear unit (ReLU) activation functions and K number of output nodes corresponding to K number of treatment options; and
create a prescriptive tree based on the ANN model, wherein each leaf node of the prescriptive tree corresponds to one of the treatment options, and wherein the prescriptive tree is configured to indicate one of the treatment options for a particular set of features of the covariate data.

10. The computer program product of claim 9, wherein the training the ANN model comprises:
using a loss function that is based on prescription outcome and prediction error; and
adjusting values of weights of the ANN model using the loss function and gradient descent.

11. The computer program product of claim 9, wherein the prescriptive tree comprises an oblique tree with hyperplane splits by using multiple weights per neuron in the ANN model.

12. The computer program product of claim 9, wherein the prescriptive tree comprises an axis-aligned tree by setting a single weight per neuron in the ANN model.

13. The computer program product of claim 9, wherein the ANN model takes a number of non-zero weights connected to each neuron as an input parameter.

14. The computer program product of claim 9, wherein the program instructions are executable to incorporate one or more constraints in the ANN model.

15. A system comprising:
a processor set, one or more computer readable storage media, and program instructions collectively stored on the one or more computer readable storage media, the program instructions executable to:
train an artificial neural network (ANN) model using a dataset comprising observational data including treatment data, outcome data, and covariate data, wherein the ANN model includes rectified linear unit (ReLU) activation functions and K number of output nodes corresponding to K number of treatment options; and
create a prescriptive tree based on the ANN model, wherein each leaf node of the prescriptive tree corresponds to one of the treatment options, and wherein the prescriptive tree is configured to indicate one of the treatment options for a particular set of features of the covariate data.

16. The system of claim 15, wherein the training the ANN model comprises:
using a loss function that is based on prescription outcome and prediction error; and
adjusting values of weights of the ANN model using the loss function and gradient descent.

17. The system of claim 15, wherein the prescriptive tree comprises an oblique tree with hyperplane splits by using multiple weights per neuron in the ANN model.

18. The system of claim 15, wherein the prescriptive tree comprises an axis-aligned tree by setting a single weight per neuron in the ANN model.

19. The system of claim 15, wherein the ANN model takes a number of non-zero weights connected to each neuron as an input parameter.

20. The system of claim 15, wherein the program instructions are executable to incorporate one or more constraints in the ANN model.
